(19) United States
(12) Patent Application Publication
(10) Pub. No.: US 2018/0135979 A1
(43) Pub. Date: May 17, 2018

(54) SWITCHING CAP AND MODE-SWITCHABLE RANGEFINDER COMPRISING THE SAME

(71) Applicant: INCONTRO SPORTS INC., Monterey Park, CA (US)

(72) Inventor: Leo Chang, Taipei (TW)

(21) Appl. No.: 15/352,568

(22) Filed: Nov. 15, 2016

(51) Int. Cl. G01C 3/04; G01C 3/08; A63B 57/00

(52) U.S. Cl. CPC G01C 3/04; G01C 3/08; A63B 2220/805; A63B 2220/20; A63B 57/00

(57) ABSTRACT

Provided is a switching cap having a plate and a block formed on the plate. Also provided is a mode-switchable rangefinder having a protection component, a housing, a binocular module, a display module, a circuit board with a photoelectric switch, a distance sensor module, and a slope sensor module. The four modules and the circuit board are disposed in the accommodation space, and the display module, the distance sensor module, and the slope sensor module are electrically connected with the circuit board. When the switching cap is in use, the block is disposed between two ends of the photoelectric switch, such that only distance information is displayed for tournament. When the protecting cap is in use, the ends of the photoelectric switch would not be isolated, such that both distance and slope information can be displayed for practice.

### BACKGROUND OF THE INVENTION

### 1. Field of the Invention

The present invention relates to a cap for a multi-functional rangefinder, more particularly to a cap for a mode-switchable multi-functional golf rangefinder. Besides, the present invention relates to a multi-functional rangefinder comprising the same, more particularly to a mode-switchable multi-functional golf rangefinder.

### 2. Description of the Prior Arts

Golf is a sport suitable for people of all ages. It is considered suitable to train the wisdom and strategic capability of the golfers while strengthening the physique, and thus playing golf becomes a pretty popular outdoor recreation activity for entrepreneurs and executives.

When playing golf, the golfer can choose a suitable golf club that fits the distance he/she desires to hit. The person who has the less stokes to hit the golf ball into the hole of the putting green wins the tournament.

Since each strike situation is affected by factors such as gradients, terrains, obstacles, and wind directions, the golfer normally employs a multi-functional rangefinder with distance and slope measurements during practice time to obtain accurate distance and slope data between the golfer and the flag on the putting green, trying to reduce the number of strokes and accumulate the golfer's experiences of estimating distance and slope.

However, according to the rules of golf set by the United States Golf Association (USGA) and Royal & Ancient Golf Association (R&A), the golfer is not allowed to obtain slope information but distance information from the rangefinder, otherwise the golfer would be disqualified. Therefore, the commercial multi-functional golf rangefinder cannot be used in the golf tournament. The golf player needs to buy two rangefinders, one is a multi-functional rangefinder for practice and the other is a single-mode golf rangefinder for tournament, thereby incurring the inconvenience.

### SUMMARY OF THE INVENTION

In view of the drawbacks in the prior art, the present invention is to overcome the inconvenience that the golfer needs to buy two different golf rangefinders for practice and tournament, thereby improving the convenience of golf sports.

To achieve the foresaid objective, the present invention provides a switching cap for a mode-switchable rangefinder. The switching cap comprises a plate, a block, and at least one connecting element. The block is formed on the plate, and the at least one connecting element is formed on one side of the plate.

Preferably, the plate has an inner surface, and the block is formed on and protrudes from the inner surface of the plate in an integral configuration. More preferably, the block is formed perpendicularly protruding from the inner surface of the plate in an integral configuration.

Preferably, the at least one connecting element is formed on and protrudes from one side of the plate in an integral configuration.

The present invention also provides a mode-switchable rangefinder, which comprises a protection component, a housing, a binocular module, a display module, a circuit board, a distance sensor module, and a slope sensor module. The housing has an opening and an accommodation space communicating with the opening. The binocular module, the display module, the circuit board, the distance sensor module, and the slope sensor module are disposed in the accommodation space. The display module, the distance sensor module, and the slope sensor module are electrically connected with the circuit board. A photoelectric switch having a receiving end and a transmitting end opposite each other is disposed on the circuit board. The protection component may be selectively installed on the housing to close the opening thereof. The protection component may be the foresaid switching cap.

When the switching cap is installed on the housing and closes the opening, the block of the switching cap is disposed between the receiving end and the transmitting end of the photoelectric switch, and thus the receiving end is opposite to the transmitting end via the block.

When the switching cap is not installed on the housing and does not close the opening, the receiving end directly faces to the transmitting end. It should be noted that the switching cap may be replaced by a conventional protecting cap if desired, and in this embodiment, the conventional protecting cap is installed on the housing to close the opening instead. In this embodiment, the receiving end of the photoelectric switch directly faces to the transmitting end because the protecting cap is formed in a planer configuration without any foresaid block.

When the receiving end is opposite to the transmitting end via the block, the slope information provided by the slope sensor module cannot be shown on the display module, and only distance information provided by the distance sensor module can be shown on the display module. When the receiving end directly faces to the transmitting end, both slope information provided by the slope sensor module and distance information provided by the distance sensor module are shown on the display module.

Preferably, the housing has a linking element, which covers the opening and having a hole. The hole of the linking element communicates with the opening of the body. When the protection component covers the housing, the opening of the body and the hole of the linking element are both closed by the protection component.

Preferably, the housing has at least one receiving recess, and the at least one connecting element is embedded in the at least one receiving recess.

Preferably, the binocular module has an eyepiece set and an objective set, both disposed on the housing.

Preferably, the switching cap and the protecting cap can be formed with different patterns on their outer surfaces. Accordingly, the two different caps differentiated from each other in bright color can be identified by the referee or other golfers to avoid unnecessary arguments whether the golfer uses the slope function in the tournament and violates the rule of golf.

By adopting the technical means of the present invention, the mode-switchable rangefinder can switch its display function by using different protection components. The golfer no more needs to buy two different golf rangefinders for different uses of practice and tournament. Accordingly, the present invention is useful to improve the convenience and reduce the cost for a golfer to play the golf.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a switching cap for a mode-switchable rangefinder in accordance with the present invention.

FIG. 2 is a perspective view of a mode-switchable rangefinder in accordance with the present invention.

FIG. 3 is an exploded view of the mode-switchable rangefinder under a first using state, and a protection component of the mode-switchable rangefinder is the switching cap as shown in FIG. 1.

FIG. 4 is a cross-sectional view of a block of the switching cap and a slotted photoelectric switch on a circuit board when the mode-switchable rangefinder is under the first using state and the switching cap is disposed on a housing of the mode-switchable rangefinder.

FIG. 5 is a display view that a user observes a display module of the mode-switchable rangefinder from an eyepiece set under the first using state.

FIG. 6 is an exploded view of the mode-switchable rangefinder under a second using state, and the protection component of the mode-switchable rangefinder is a conventional cap.

FIG. 7 is a display view that a user observes a display module of the mode-switchable rangefinder from the eyepiece set under the second using state.

### DETAILED DESCRIPTION OF THE PREFERRED EMBODIMENTS

Hereinafter, one skilled in the arts can easily realize the advantages and effects of the present invention from the following examples. It should be understood that the descriptions proposed herein are just preferable examples only for the purpose of illustrations, not intended to limit the scope of the invention. Various modifications and variations could be made in order to practice or apply the present invention without departing from the spirit and scope of the invention.

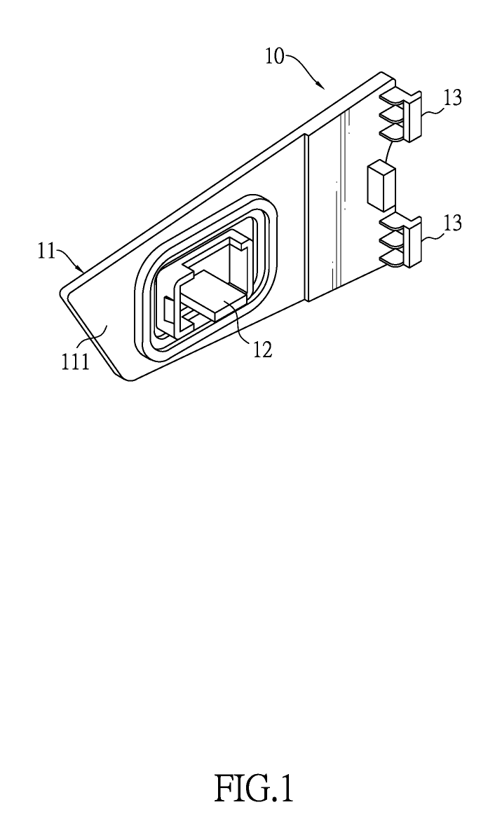

A representative example of a switching cap for a mode-switchable rangefinder in accordance with the present invention is illustrated in FIG. 1. The switching cap 10 comprises a plate 11, a block 12, and two connecting elements 13. The block 12 is formed on the plate 11. The connecting elements 13 are formed on and protrude from one side of the plate 11, such that the switching cap 10 can be installed onto a housing of the mode-switchable rangefinder through the connecting elements 13. The block 12 is formed protruding perpendicularly from an inner surface 111 of the plate 11. The connecting elements 13 are formed on and protrude from one side of the inner surface 111 of the plate 11 and are spaced from each other at an interval. The plate 11 has two opposite long sides and two opposite short sides. Specifically, the block 12 is formed protruding perpendicularly from the inner surface 111 of the plate 11 in an integral configuration, and the connecting elements 13 are formed on and protrude from the short sides of the inner surface 111 of the plate 11 in an integral piece.

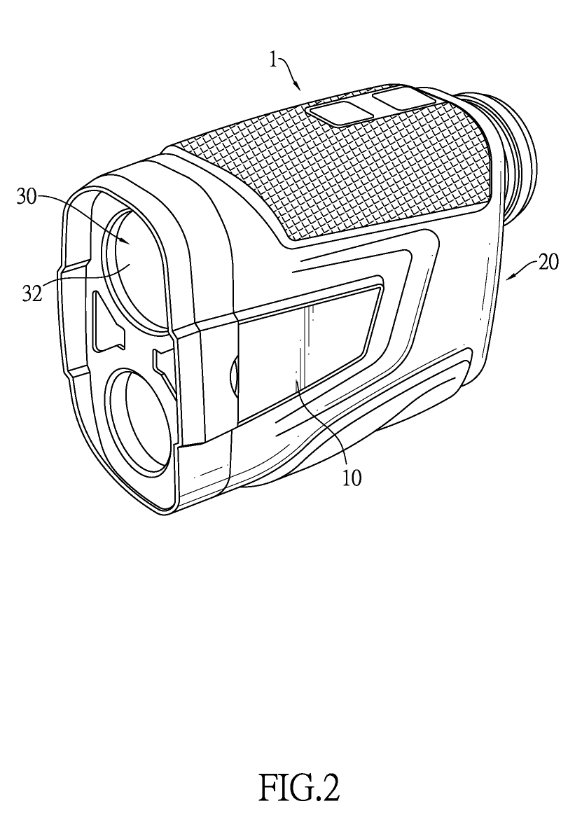

In accordance with the mode-switchable rangefinder of the present invention, a user can choose a suitable protection component depending on needs, so as to switch the measurement information on the display image. Under a first using state, i.e., the mode-switchable rangefinder 1 of the present invention is used in a tournament, and a switching cap 10 as shown in FIG. 1 is chosen to be the protection component. Here, the mode-switchable rangefinder adapted for the first using state is shown in FIGS. 2 to 4.

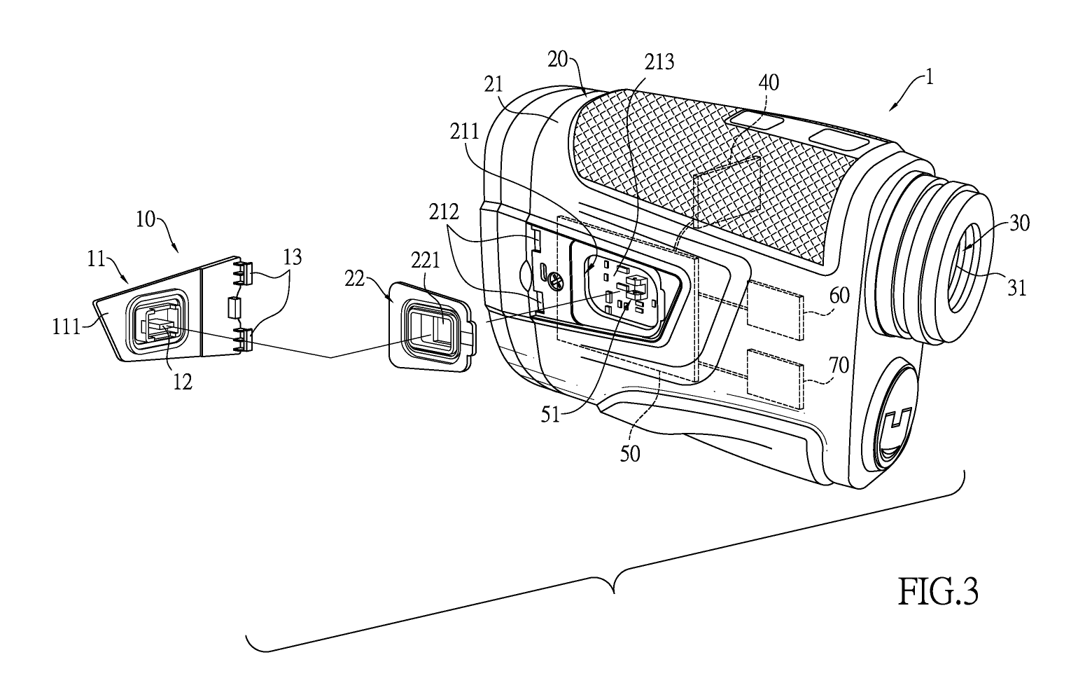

With reference to FIGS. 2 and 3, the mode-switchable rangefinder 1 of the present invention has the foresaid switching cap 10, a housing 20, a binocular module 30, a display module 40, a circuit board 50, a distance sensor module 60, and a slope sensor module 70.

The housing 20 has a body 21, and the body 21 has an opening 211 and two receiving recesses 212. The body 21 of the housing 20 further has an accommodation space 213 therein. The receiving recesses 212 are spaced from each other at an interval, which is identical to the interval between the connecting elements 13. The accommodation space 213 communicates with the opening 211 and the receiving recesses 212. Besides, the housing 20 further has a linking element 22 covering the opening 211 of the body 21, and the linking element 22 has a hole 221 communicating with the opening 211 of the body 21.

The binocular module 30 is disposed in the accommodation space 213 of the housing 20. The binocular module 30 has an eyepiece set 31 and an objective set 32, both disposed on the housing 20.

The display module 40 is also disposed in the accommodation space 213 of the housing 20, and is disposed between the eyepiece set 31 and the objective set 32.

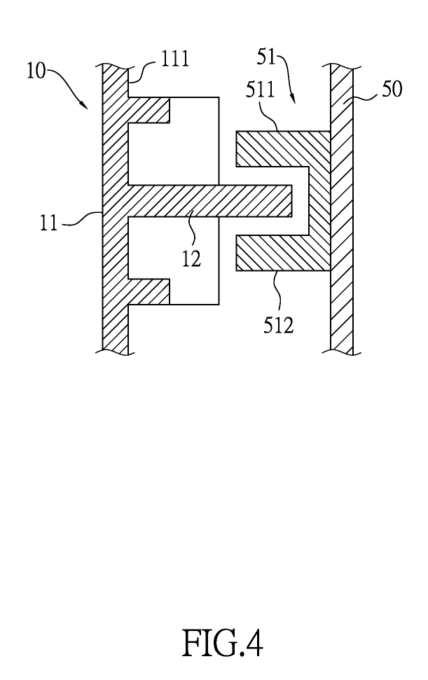

The circuit board 50, the distance sensor module 60, and the slope sensor module 70 are disposed in the accommodation space 213 of the housing 20, and the display module 40, the distance sensor module 60, and the slope sensor module 70 are electrically connected with the circuit board 50. The distance sensor module 60 and the slope sensor module 70 are respectively used to sense the distance and the slope between the golfer and the target flag, and then allow the distance and the slope information to be shown on the display module 40. With reference to FIGS. 3 and 4, a slotted photoelectric switch 51 is disposed on the circuit board 50, and the slotted photoelectric switch 51 has a receiving end 511 and a transmitting end 512 opposite the receiving end 511. The slotted photoelectric switch 51 can be used to control the data shown on the display module 40.

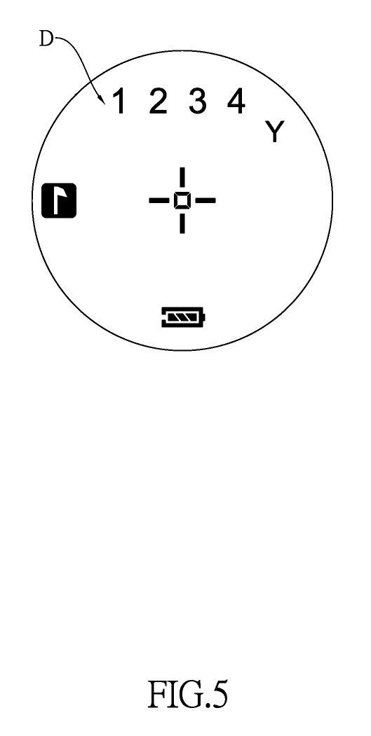

Under the first using state, the connecting elements 13 of the switching cap 10 is embedded in the receiving recesses 212 of the housing 20 to allow the switching cap 10 to be installed on the housing 20, such that the opening 211 of the body 21 and the hole 221 of the linking element 22 are closed by the switching cap 10. With reference to FIG. 4, when the switching cap 10 is installed on the housing 20, the block 12 is disposed between the receiving end 511 and the transmitting end 512 of the slotted photoelectric switch 51. That is, the receiving end 511 is opposite to the transmitting end 512 through the block 12. Under this using state, a user only can get distance information D from the distance sensor module 60 by observing the display module 40 of the mode-switchable rangefinder 1, as shown in FIG. 5.

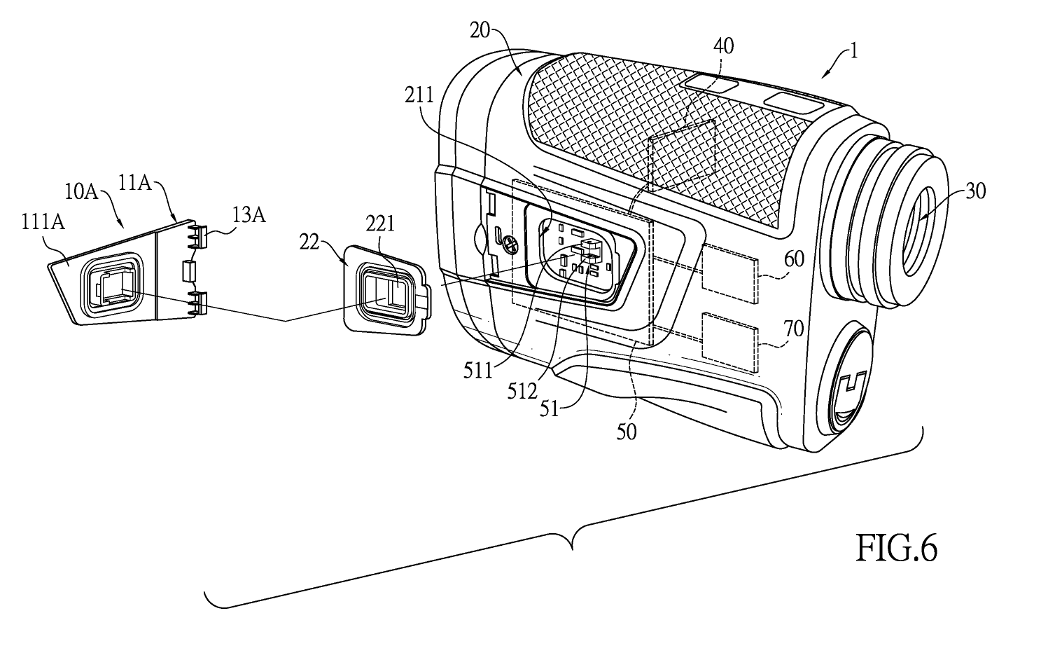

Under a second using state, i.e., the mode-switchable rangefinder 1 of the present invention is used in practice to train the ability of estimating distance and slope, and a conventional protecting cap 10A is chosen to be the protection component. The mode-switchable rangefinder adapted for the second using state is shown in FIG. 6.

As stated above, the mode-switchable rangefinder 1 also has the foresaid housing 20, the linking element 22, the binocular module 30, the display module 40, the circuit board 50, the distance sensor module 60, and the slope sensor module 70. No switching cap is installed on the housing 20, but the conventional protecting cap 10A is installed on the housing instead. The protecting cap 10A does not have any block formed protruding from the inner surface 111A thereof.

Specifically, the protecting cap 10A has a plate 11A and two connecting elements 13A, and the connecting elements 13A are formed on and protrude from the short sides of the inner surface 111A of the plate 11A, such that the protecting cap 10A can be installed on the housing 20 of the mode-switchable rangefinder 1 through the connecting elements 13A.

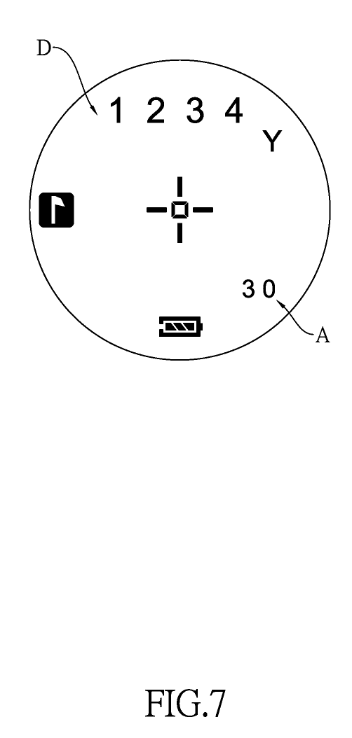

When in use, the connecting elements 13A of the protecting cap 10A is embedded in the receiving recesses 212 of the housing 20 to allow the protecting cap 10A to be installed on the housing 20, such that the opening 211 of the body 21 and the hole 221 of the linking element 22 are closed by the protecting cap 10A. Because the protecting cap 10A is formed without any block, no isolation component is disposed between the receiving end 511 and the transmitting end 512 of the slotted photoelectric switch 51 when the protecting cap 10A is installed on the housing 20. That is, the receiving end 511 directly faces to the transmitting end 512. Accordingly, as shown in FIG. 7, the user can get both of the distance information D from the distance sensor module 60 and the slope information A from the slope sensor module 70 by observing the display module 40 of the mode-switchable rangefinder 1.

By adopting the technical features of the present invention, the mode-switchable rangefinder can switch its display information by using different protection components. When the golfer uses the mode-switchable rangefinder in a golf tournament, a switching cap with a block is adopted to separate the receiving end and the transmitting end, such that only distance information is provided by the mode-switchable rangefinder. Accordingly, the mode-switchable rangefinder is allowed to be used in the golf tournament. When the golfer uses the mode-switchable rangefinder during practice, a conventional protecting cap without any block is adopted to allow the receiving end to directly face the transmitting end, such that both distance and slope information can be obtained from the mode-switchable rangefinder and the user can use the mode-switchable rangefinder to train the ability to estimate distance and slope from repeated practices. To sum up, the present invention can overcome inconvenience that the golfer needs to buy two different golf rangefinders for practice and tournament, and thus improve the convenience and save the cost on playing golf.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A switching cap for a mode-switchable rangefinder, the switching cap having a plate, a block, and at least one connecting element, wherein the block is formed on the plate and the at least one connecting element is formed on one side of the plate.

2. The switching cap for the mode-switchable rangefinder as claimed in claim 1, wherein the plate has an inner surface, and the block is formed on and protrudes from the inner surface of the plate in an integral configuration.

3. The switching cap for the mode-switchable rangefinder as claimed in claim 2, wherein the block is formed on and protrudes perpendicularly from the inner surface of the plate in an integral configuration

4. The switching cap for the mode-switchable rangefinder as claimed in claim 1, wherein the at least one connecting element is formed on and protrudes from one side of the plate in an integral configuration.

5. The switching cap for the mode-switchable rangefinder as claimed in claim 2, wherein the at least one connecting element is formed on and protrudes from one side of the plate in an integral configuration.

6. The switching cap for the mode-switchable rangefinder as claimed in claim 3, wherein the at least one connecting element is formed on and protrudes from one side of the plate in an integral configuration.

7. A mode-switchable rangefinder, having a protection component, a housing, a binocular module, a display module, a circuit board, a distance sensor module, and a slope sensor module;
wherein the housing has an opening and an accommodation space communicating with the opening; the binocular module, the display module, the circuit board, the distance sensor module, and the slope sensor module are disposed in the accommodation space of the housing; the display module, the distance sensor module, and the slope sensor module are electrically connected with the circuit board; a photoelectric switch is disposed on the circuit board, and the photoelectric switch has a receiving end and a transmitting end opposite the receiving end; the protection component is selectively installed on the housing and closes the opening of the housing, and the protection cap is the switching cap as claimed in claim 1;
wherein the block of the switching cap is disposed between the receiving end and the transmitting end of the photoelectric switch and the receiving end is opposite to the transmitting end via the block when the switching cap covers the housing and closes the opening of the housing, and the receiving end directly faces to the transmitting end when the switching cap does not cover the housing.

8. The mode-switchable rangefinder as claimed in claim 7, wherein the housing has a linking element covering the opening and formed with a hole, the hole of the linking element communicates with the opening of the housing, and the hole of the linking element and the opening of the housing are closed by the protection component.

9. The mode-switchable rangefinder as claimed in claim 7, wherein the housing has at least one receiving recess, and the at least one connecting element is embedded in the at least one receiving recess.

10. The mode-switchable rangefinder as claimed in claim 7, wherein the binocular module has an eyepiece set and an objective set, and the eyepiece set and the objective set are disposed on the housing.

11. The mode-switchable rangefinder as claimed in claim 7, wherein the plate of the switching cap has an inner surface, and the block is formed on and protrudes from the inner surface of the plate in an integral configuration.

12. The mode-switchable rangefinder as claimed in claim 11, wherein the block of the switching cap is formed on and protrudes perpendicularly from the inner surface of the plate in an integral configuration.

13. The mode-switchable rangefinder as claimed in claim 7, wherein the at least one connecting element of the switching cap is formed on and protrudes from one side of the plate in an integral configuration.

14. The mode-switchable rangefinder as claimed in claim 7, wherein slope information provided by the slope sensor module is not shown on the display module and distance information provided by the distance sensor module is shown on the display module when the receiving end is opposite to the transmitting end with the block disposed between the receiving end and the transmitting end.

15. The mode-switchable rangefinder as claimed in claim 7, wherein slope information provided by the slope sensor module and distance information provided by the distance sensor module are shown on the display module when the receiving end directly faces to the transmitting end.

16. The mode-switchable rangefinder as claimed in claim 8, wherein slope information provided by the slope sensor module is not shown on the display module and distance information provided by the distance sensor module is shown on the display module when the receiving end is opposite to the transmitting end with the block disposed between the receiving end and the transmitting end.

17. The mode-switchable rangefinder as claimed in claim 8, wherein slope information provided by the slope sensor module and distance information provided by the distance sensor module are shown on the display module when the receiving end directly faces to the transmitting end.

18. The mode-switchable rangefinder as claimed in claim 11, wherein slope information provided by the slope sensor module is not shown on the display module and distance information provided by the distance sensor module is shown on the display module when the receiving end is opposite to the transmitting end with the block disposed between the receiving end and the transmitting end.

19. The mode-switchable rangefinder as claimed in claim 11, wherein slope information provided by the slope sensor module and distance information provided by the distance sensor module are shown on the display module when the receiving end directly faces to the transmitting end.
